(19) United States
(12) Patent Application Publication
(10) Pub. No.: US 2025/0178462 A1
(43) Pub. Date: Jun. 5, 2025

(54) HYBRID POWER CONVERTER CONNECTED TO AN ENERGY STORAGE SYSTEM

(71) Applicant: Rivian IP Holdings, LLC, Irvine, CA (US)

(72) Inventors: Lixiang Wei, Irvine, CA (US); Yang Liu, Irvine, CA (US); Steven Schulz, Torrance, CA (US); Silva Hiti, Redondo Beach, CA (US)

(21) Appl. No.: 18/529,695

(22) Filed: Dec. 5, 2023

(51) Int. Cl. B60L 53/14; B60L 53/62; H02J 7/04

(52) U.S. Cl. CPC B60L 53/14; B60L 53/62; H02J 7/04

(57) ABSTRACT

Systems and methods are provided for a hybrid power converter connected to an integrated energy storage system (ESS). In some embodiments, the system includes a first direct current to direct current (DC/DC) converter configured to provide DC input power to an ESS in a first mode of operation and to receive stored power from the ESS and provide the stored power to a common DC bus in a second mode of operation, and a second DC/DC converter configured to receive at least a portion of the stored power from the common DC bus and provide it to a load in the second mode of operation.

### INTRODUCTION

The present disclosure is directed to power electronics equipment for providing power to a load and/or an energy storage system. More specifically, the present disclosure is directed to hybrid power conversion systems configured to operate in multiple modes such that power is flexibly stored or retrieved from an integrated energy storage system.

### SUMMARY

In accordance with some embodiments of the present disclosure, systems and methods are provided for a hybrid power converter connected to an integrated energy storage system (ESS). In some embodiments, the system includes a first direct current to direct current (DC/DC) converter configured to provide DC input power to an ESS in a first mode of operation and to receive stored power from the ESS and provide the stored power to a common DC bus in a second mode of operation, and a second DC/DC converter configured to receive at least a portion of the stored power from the common DC bus and provide it to a load in the second mode of operation.

In some embodiments, the second DC/DC converter is further configured to provide input power to the ESS in the first mode of operation. In some embodiments, the first and second DC/DC converters are each electrically isolated and configurable to provide bidirectional power flow.

In some embodiments, the system further includes at least one alternating current to direct current (AC/DC) converter configured to provide the input power to the common DC bus in the first mode of operation.

In some embodiments, the first DC/DC converter is configured to provide input power to a load in a third mode of operation.

In some embodiments, the first DC/DC converter is configured to receive a portion of stored power from the ESS and provide it to the common DC bus for grid forming or grid support in a fourth mode of operation. In some embodiments, the system further includes at least one AC/DC converter configured to receive the portion of the stored power from the common DC bus and provide it for the grid forming or grid support in the fourth mode of operation. In some embodiments, the second DC/DC converter is inactive in the fourth mode of operation.

In some embodiments, the system further includes a plurality of DC/DC converters including the first DC/DC converter and the second DC/DC converter, and a switching matrix configured to connect or disconnect an input of each of the plurality of DC/DC converters to the common DC bus.

In some embodiments, the system further includes a plurality of DC/DC converters including the first DC/DC converter and the second DC/DC converter, and a switching matrix configured to connect or disconnect an output of each of the plurality of DC/DC converters to a plurality of loads, wherein the plurality of loads comprises the ESS and at least one electric vehicle.

In some embodiments, the system further includes a first power electronics module (PEM) including a first AC/DC converter having an output coupled to an input of the first DC/DC converter, and a second PEM comprising a second AC/DC converter having an output coupled to the input of the second DC/DC converter.

In some embodiments, the methods of the present disclosure includes, in a first mode of operation, providing input power from a first DC/DC converter to an ESS, and, in a second mode of operation, providing stored power from the ESS to a common DC bus using the first DC/DC converter and providing at least a portion of the stored power from the common bus to a load using a second DC/DC converter.

In some embodiments, the method further includes, in the first mode of operation, providing input power from the second DC/DC converter to the ESS.

In some embodiments, the method further includes, in the first mode of operation, providing the input power to the common DC bus using at least one alternating current to direct current (AC/DC) converter.

In some embodiments, the method further includes, in a third mode of operation, providing input power to a load using the first DC/DC converter.

In some embodiments, the method further includes, in a fourth mode of operation, using the first DC/DC converter to receive a portion of the stored power from the ESS and provide it to the common DC bus for grid forming or grid support. In some embodiments, the method further includes, in the fourth mode of operation, using at least one AC/DC converter to receive the portion of the stored power from the common DC bus and provide it for the grid forming or grid support. In some embodiments, the method further includes, in the fourth mode of operation, inactivating the second DC/DC converter.

In some embodiments, the method further includes connecting or disconnecting an input of each of a plurality of DC/DC converters to the common DC bus using a switching matrix, wherein the plurality of DC/DC converters includes the first DC/DC converter and the second DC/DC converter.

In some embodiments, the method further includes, connecting or disconnecting an output of each of a plurality of DC/DC converters to a plurality of loads using a switching matrix, wherein the plurality of DC/DC converters includes the first DC/DC converter and the second DC/DC converter and wherein the plurality of loads comprises the ESS and at least one electric vehicle.

In some embodiments, the system includes a first PEM including a first AC/DC converter coupled to a first DC/DC converter, a second PEM including a second AC/DC converter coupled to a second DC/DC converter, a common DC bus selectively connectable to the first PEM between the first AC/DC converter and the first DC/DC converter and to the second PEM between the second AC/DC converter and the second DC/DC converter, and an ESS. In a first mode of operation, the first DC/DC converter is configured to provide DC input power to the ESS, and in a second mode of operation, the first DC/DC converter is configured to receive stored power from the ESS and provide the stored power to the common DC bus and the second DC/DC converter is configured to receive at least a portion of the stored power from the common DC bus and provide it to an electric vehicle.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 shows an illustrative block diagram of an electric vehicle charging system including power electronics equipment for providing power to a load and/or an energy storage system, in accordance with some embodiments of the disclosure;

FIG. 2 is an illustrative block diagram showing additional details of some components of power electronics equipment, in accordance with some embodiments of the disclosure;

FIG. 3 is an illustrative depiction of power flows during a first mode of operation of the power electronics equipment, in accordance with some embodiments of the present disclosure;

FIG. 4 is an illustrative depiction of power flows during a second mode of operation of the power electronics equipment, in accordance with some embodiments of the present disclosure;

FIG. 5 is an illustrative depiction of power flows during a third mode of operation of the power electronics equipment, in accordance with some embodiments of the present disclosure;

FIG. 6 is an illustrative depiction of power flows during a fourth mode of operation of the power electronics equipment, in accordance with some embodiments of the present disclosure;

FIG. 7 is an illustrative state diagram describing various modes of operation of the power electronics equipment, in accordance with some embodiments of the present disclosure; and

FIG. 8 is an illustrative flowchart of a method for providing power to a load and/or an energy storage system, in accordance with some embodiments of the disclosure.

### DETAILED DESCRIPTION

Power electronics equipment may be used to provide power to a load and/or an energy storage system. When an electric grid provides alternating current (AC) electricity to power electronics equipment, the power electronics equipment may be used to convert the AC power to direct current (DC) power because DC power may be needed to power certain loads (e.g., charging electric vehicles or energy storage systems). In some embodiments, after converting the AC power to a first DC power, the power electronics equipment may convert the first DC power to a second DC power with a different voltage level than the first DC power. For example, the first DC power may have a voltage level similar to that of the electric grid connection providing the AC power, whereas the second DC power may have a higher or lower voltage level according to the specifications of the load being powered by the power electronics equipment.

In some embodiments, power electronics equipment may also receive DC power. For example, power electronics equipment may receive a first DC power from one of an electric vehicle or an energy storage system, convert that first DC power to one of a second DC power or an AC power, and then use that second DC power or AC power to power certain loads (e.g., electric vehicles, energy storage systems, heaters, compressors, household appliances, loads connected to the grid, other DC-powered loads, other AC-powered loads, or any combination thereof) that require DC or AC power. In some embodiments, the power electronics equipment may modify the voltage level of the first DC power to provide a second DC power that is suitable for the load being powered.

To perform at least the abovementioned power conversion operations, it may be desirable to have a single package of power electronics equipment that is configurable to perform all these operations. In some embodiments, such power electronics equipment may be configurable to perform various modes of operation (e.g., AC-to-DC conversion, DC-to-AC conversion, DC-to-DC conversion, AC-to-AC conversion, other suitable power conversion modes, or any combination thereof). For example, such power electronics equipment may be configurable to receive and provide power to any one or more of an electric vehicle, an energy storage system, an electric grid, equipment configured to operate on AC power, or equipment configured to operate on DC power.

In accordance with some embodiments of the present disclosure, a power electronics system is configured to operate in multiple modes, each of which may be specific to one or more power conversion operations. In some embodiments, the system includes an AC power input/output, multiple PEMs each including a respective AC/DC converter and DC/DC converter, a DC bus that is common to the respective DC/DC converters, one or more switching matrix, a DC power input/output, and an ESS. To perform various power conversion operations, the components of the system may be dynamically configurable to operate according to the requirements of each respective power conversion operation. In some embodiments, multiple power conversion operations may be performed simultaneously (e.g., the power electronics system may simultaneously charge an electric vehicle and an ESS).

In some embodiments, each PEM is coupled to two or more of an AC electric grid, one or more AC loads, one or more DC loads, and the ESS. The PEMs may be configured to operate in parallel (e.g., each PEM receives a power input and supplies a load) or they may be configured to operate in series (e.g., one PEM supplies power to another PEM). Each DC-DC converter of each PEM may be electrically isolated (e.g., with respect to the other power converters and loads) and may be configured to support bidirectional power flow (e.g., either side of the DC-DC converter may serve as a power input or a power output).

Based on the dynamic configuration of the power electronics system and the PEMs therein, various power conversion operations can be performed with convenience, resilience, reliability, broad integration capabilities, safety, and cost-effectiveness. For example, under conditions where an AC grid can supply adequate power, the power electronics system may use the AC electricity to power one or more electric vehicle, the ESS, any other suitable DC load, or any combination thereof. However, under conditions where an AC grid cannot supply adequate power, the power electronics system may use the ESS to power one or more electric vehicle, another ESS, any other suitable load, or any combination thereof. In addition, under conditions where it may be beneficial to provide AC power (e.g., for grid islanding, grid support, powering of AC loads, or any combination thereof) the power electronics system may use energy from the ESS to provide AC power. In some embodiments, a power electronics system performs all the abovementioned operations through at least the configuration of a switching matrix and one or more respective PEMs.

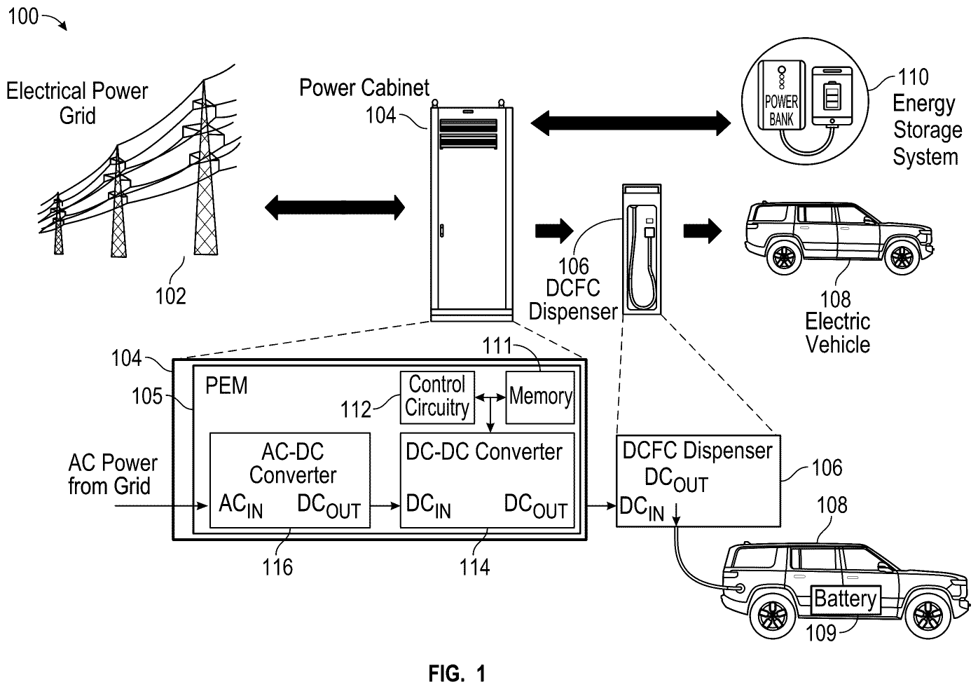

FIG. 1 depicts an illustrative block diagram 100 of an electric vehicle charging system including power electronics equipment for providing power to a load and/or an ESS, in accordance with some embodiments of the disclosure. Power is input to the system by electrical power grid 102, which is coupled to power cabinet 104. Power cabinet 104 is coupled to direct current fast charge (DCFC) dispenser 106. Through a direct connection or through dispenser 106, power cabinet 104 ultimately delivers power to at least one of electric vehicle 108 (specifically battery 109 therein) and/or energy storage system (ESS) 110. Power cabinet 104 includes one or more power electronics module (PEM) 105, which includes memory 111 and control circuitry 112, where memory 111 may include instructions for operating control circuitry 112 according to the various operation modes described above and as further discussed below.

PEM 105 also includes DC to DC converter 114, which conditions the DC power to be properly received by electric vehicle 108 or ESS 110. In some embodiments, DC to DC converter 114 is electrically isolated from other components of block diagram 100 and is configured for bidirectional flow (e.g., DC to DC converter can send either power to or receive power from DCFC dispenser 106 or ESS 110). Additionally included in PEM 105 is AC to DC converter 116, which may convert incoming AC power from the electric grid to a first DC power that can then be converted into a second DC power for powering connected loads. In some embodiments, AC to DC converter 116 may convert incoming DC power (e.g., from electric vehicle 108 or ESS 110) to AC power that may be supplied to the electric grid (e.g., to provide grid support) or AC loads (e.g., to provide backup power, grid islanding, supplemental power, any other suitable source of AC power, or any combination thereof).

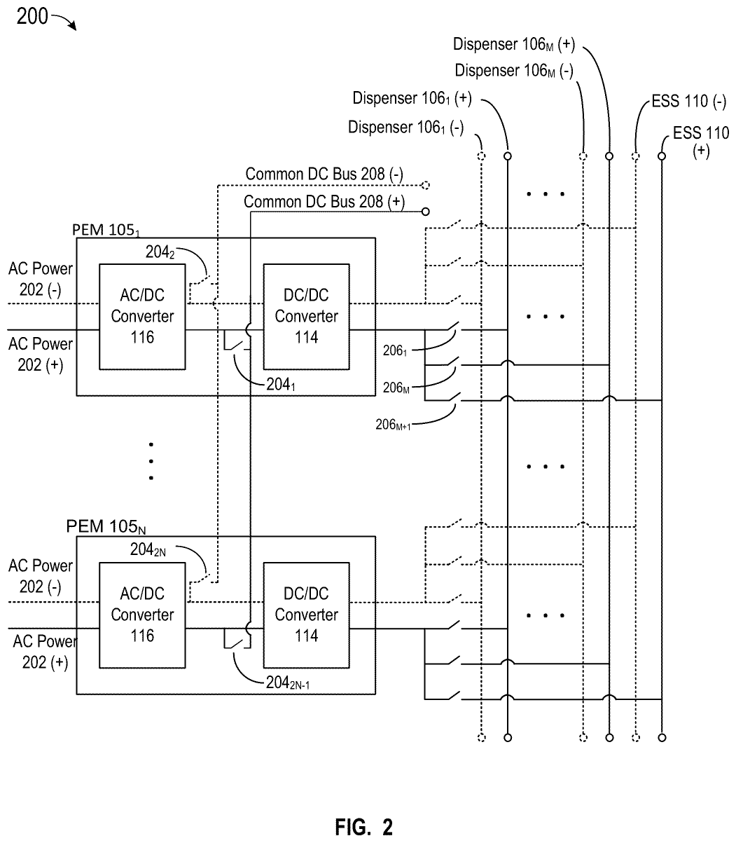

FIG. 2 is an illustrative block diagram 200 showing additional details of some components of power electronics equipment, in accordance with some embodiments of the disclosure. The power electronics equipment includes multiple PEMs 105, each of which contains a respective AC/DC converter 116, DC/DC converter 114, power couplings (e.g., to AC power 202, to common DC bus 208, and to dispenser 106 and/or ESS 110) and switches (e.g., matrix of switches 204 and matrix of switches 206). A first side of each respective PEM 105 is coupled to AC power 202, which may represent an input power (e.g., from an electric grid) or an output power (e.g., from ESS 110). A second side of each respective PEM 105 is coupled to one or more dispenser 106 and one or more ESS 110. This second side of each respective PEM 105 may be coupled to a load (e.g., an electric vehicle connected to dispenser 106 or charging ESS 110) or a power source (e.g., discharging ESS 110). A first matrix of switches 206 (i.e., a switching matrix) determines how the second side of each respective PEM couples to the one or more dispenser 106 and one or more ESS 110. For example, each switch 206 may be opened or closed according to various operation modes, as explained above and as further explained below. As shown, each of the power couplings to a respective PEM contains a positive line and a negative line, which may respectively correspond to power and ground connections. Each such line may have a respective switch, as shown. While FIG. 2 only labels three of the switches 206, it will be understood that the switch configuration as shown is extendible to any number of ‘M’ dispensers 106 and any number of ‘N’ PEMs 105, including positive and negative lines thereof. In some embodiments, switches to ground connections, e.g., as attached to lines 106₁ (-), 106_{M} (-), and 110 (-), may not be included in the power electronics equipment.

As shown in FIG. 2, the power electronics equipment also includes a common DC bus 208 and a second matrix of switches 204 (i.e., a switching matrix). In some embodiments, the common DC bus 208 is configured between each AC/DC converter 116 and DC/DC converter 114, such that respective PEMs 105 may share power according to the configuration of the switches 204 and the target mode of operation. Via the common DC bus 208, power from a first PEM (e.g., PEM 105₁) may be transferred to one or more second PEMs (e.g., PEM 105_{N}). For example, to charge a load without using AC power 202, PEM 105₁ may draw stored power from ESS 110 and provide the stored power to the common DC bus 208, from which PEM 105_{N} may receive at least a portion of the stored power and provide it to one or more load (e.g., an electric vehicle) coupled to one or more dispenser 106. To perform such an operation, each DC/DC converter 114 may be configurable to support bidirectional power flows (e.g., to provide or receive power). In some embodiments, each pair of switches 204 associated with a respective PEM 105 may be open when that PEM is electrically isolated from the other PEMs and may be closed when that PEM is electrically coupled to the other PEMs via common DC bus 208. Thus, each DC/DC converter 114 may be configurable to be electrically isolated from or electrically coupled to other DC/DC converters 114 and common DC bus 208. Moreover, according to various configurations and modes of operation of the power electronics system, a DC/DC converter 114 of a PEM 105 may be electrically isolated from the AC/DC converter 116 of the PEM and/or from one or more connections at the second side of the PEM (e.g., one or more dispenser 106 and ESS 110). In some embodiments, switches to ground connections (e.g., switch 204₂ and 204_{2N}) may not be included in the power electronics equipment.

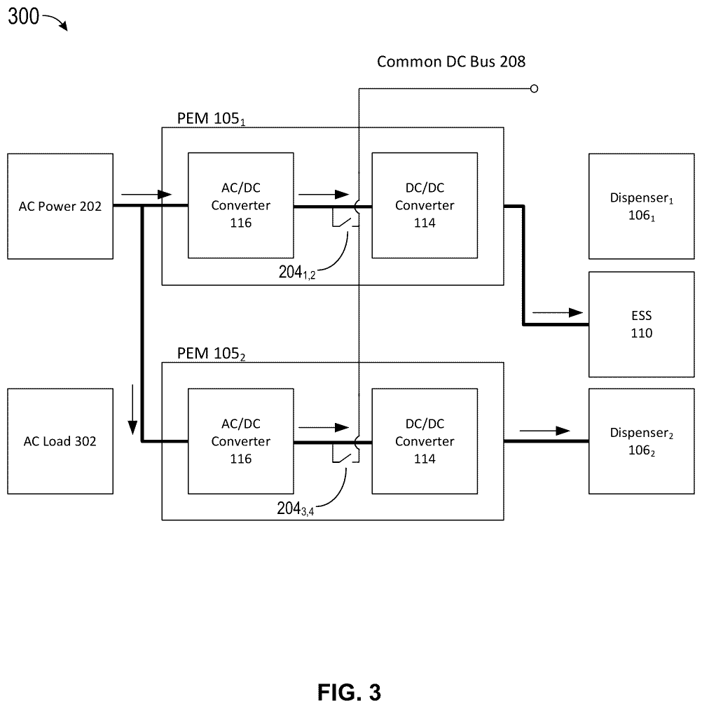

FIGS. 3-6 show illustrative depictions of power flows for four power operation modes. It will be understood that while FIG. 2 shows discrete positive and negative lines corresponding to each electrical connection, these lines are combined together (i.e., into a single line) for ease of viewing when displaying the corresponding electrical connections in FIGS. 3-6. It will be understood that the concepts shown in FIGS. 3-6 are applicable to systems with two or more PEMs, as shown in FIG. 2, and only two PEMs are shown in FIGS. 3-6 for ease of viewing when displaying representative power flows. Likewise, each switch (i.e., switches 204_{1,2} and 204_{3,4}) of FIGS. 3-6 represents a pair of switches (e.g., switches 204₁ and 204₂, or switches 204_{2N-1} and 204_{2N} as shown in FIG. 2) that are lumped together for ease of viewing. However, in some embodiments, switches to ground connections (e.g., switch 204₂ and 204₄) may not be included in the power electronics equipment. Moreover, while the matrix of switches 206 is omitted from FIGS. 3-6 for ease of viewing, it will be understood that these switches 206 may be dynamically engaged (i.e., turned on or off) according to various configurations that may perform the power operation modes shown therein. Moreover, while FIGS. 3-6 may show a first DC/DC converter supporting a first power flow and a second DC/DC converter supporting a second power flow, different from the first, these configurations as shown are merely illustrative of one instance of each respective mode of operation; in practice, any combination of two or more PEMs (and AC/DC or DC/DC converter therein) may be configured to provide any power flow (e.g., to provide power to or receive power from one or more dispenser 106, to provide power to or receive power from one or more ESS 110, to receive AC power 202, to provide power to an AC load 302, to perform any other suitable power operation, or any combination thereof) that is directly shown or otherwise suggested in FIGS. 3-6. These power flows may be performed according to various configurations of the PEM, including configurations of the power converters therein and the connections made by the matrix of switches 204 and the matrix of switches 206.

FIG. 3 is an illustrative depiction of power flows during a first mode of operation 300 of the power electronics equipment, in accordance with some embodiments of the present disclosure. In some embodiments, the first mode of operation corresponds to simultaneous charging of an ESS (e.g., ESS 110) and an electric vehicle (e.g., via dispenser 106₂) using AC power 202, as shown. In some embodiments, an electric grid (e.g., electrical power grid 102) is the source of the AC power 202, though the input power may also be provided by other sources (e.g., any suitable energy generator). As shown by the arrows and the bolded lines of FIG. 3, power flows from AC power 202, through respective PEMs 105₁ and 105₂, and respectively to ESS 110 and dispenser 106₂. During the first mode of operation 300, switches 204_{1,2} and 204_{3,4} may be open and power may not flow through common DC bus 208. However, it will be understood that in some embodiments switches 204_{1,2} and 204_{3,4} may be closed and power may flow through common DC bus 208.

The first mode of operation 300 shown in FIG. 3 may correspond to charging ESS 110 in parallel with one or more electric vehicles (via one or more dispenser 106) using AC power 202 from an electric power grid. In such a mode of operation, the ESS 110 may store power for later providing the stored power to one or more dispenser 106 (e.g., to charge an electric vehicle), one or more AC load 302 (e.g., to support the grid, provide an islanded grid, power equipment that runs on AC electricity, or any combination thereof), one or more other suitable load, or any combination thereof.

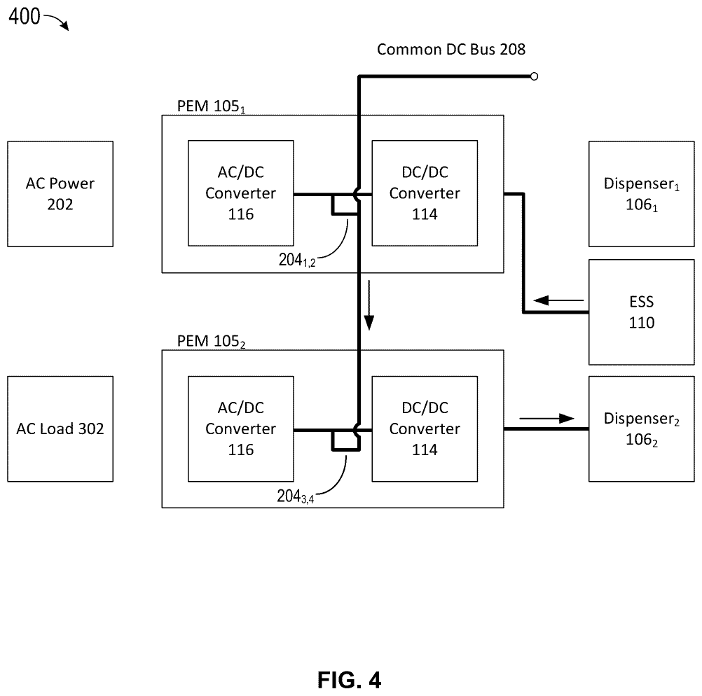

FIG. 4 is an illustrative depiction of power flows during a second mode of operation 400 of the power electronics equipment, in accordance with some embodiments of the present disclosure. In some embodiments, the second mode of operation corresponds to receiving stored power from one or more ESS (e.g., ESS 110) and providing the stored power to one or more electric vehicle (e.g., via dispenser 106₂), as shown. As shown by the arrows and the bolded lines of FIG. 3, power flows from ESS 110, through PEMs 105₁ and 105₂, respectively, and to dispenser 106₂. During the second mode of operation 400, switches 204_{1,2} and 204_{3,4} is closed such that power flows through common DC bus 208. This power flow couples PEM 105₁ (and DC/DC converter 114 therein) to PEM 105₂ (and DC/DC converter 114 therein) such that the former PEM receives stored power from ESS 110 and the latter PEM provides a portion of the stored the stored power to dispenser 106₂.

The second mode of operation 400 shown in FIG. 4 may correspond to charging one or more electric vehicles (via one or more dispenser 106) using power stored in ESS 110. This mode of operation may be desirable when AC power 202 is unavailable (e.g., during a blackout or in an off-grid configuration), and it may also be desirable when AC power 202 is available to provide more renewable or less costly power (e.g., to an electric vehicle).

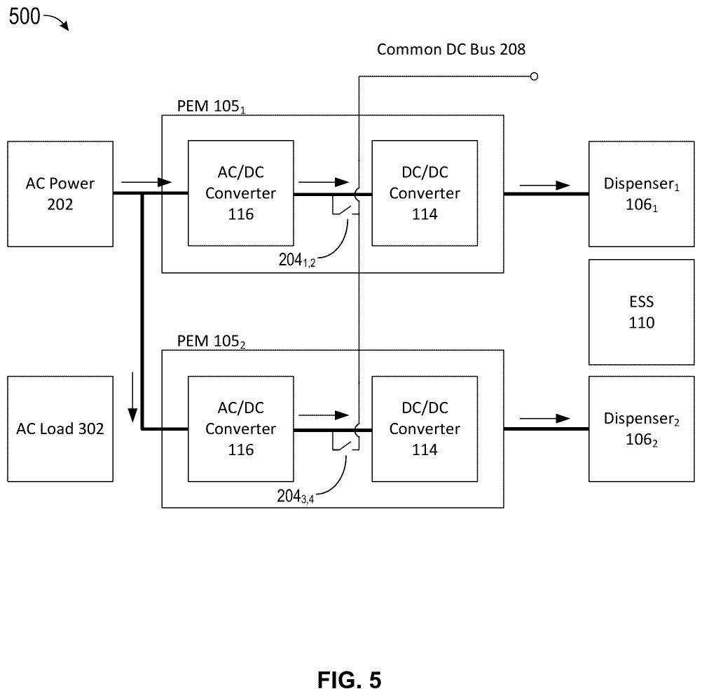

FIG. 5 is an illustrative depiction of power flows during a third mode of operation 500 of the power electronics equipment, in accordance with some embodiments of the present disclosure. In some embodiments, the third mode of operation corresponds to simultaneous charging of multiple electric vehicles (e.g., via dispensers 106₁ and 106₂) using AC power 202, as shown. As shown by the arrows and the bolded lines of FIG. 5, power flows in parallel from AC power 202, through respective PEMs 105₁ and 105₂, and to respective dispensers 106₁ and 106₂. During the third mode of operation 500, switches 204_{1,2} and 204_{3,4} may be open such that no power may flow through common DC bus 208. However, it will be understood that in some embodiments switches 204_{1,2} and 204_{3,4} may be closed and power may flow through common DC bus 208.

The third mode of operation 500 shown in FIG. 5 may correspond to charging multiple electric vehicles (via multiple dispensers 106) using AC power 202 from an electric power grid. In such a mode of operation, each respective dispenser 106 may receive a particular quantity of power from its respective PEM 105 that is determined, for example, according to the charging requirements of a load connected thereto. For example, control circuitry 112 of PEM 105 may determine the particular quantity of power based on the charge state of respective electric vehicle battery 109, instructions stored in memory 111, real-time information about power availability, any other suitable information, or any combination thereof.

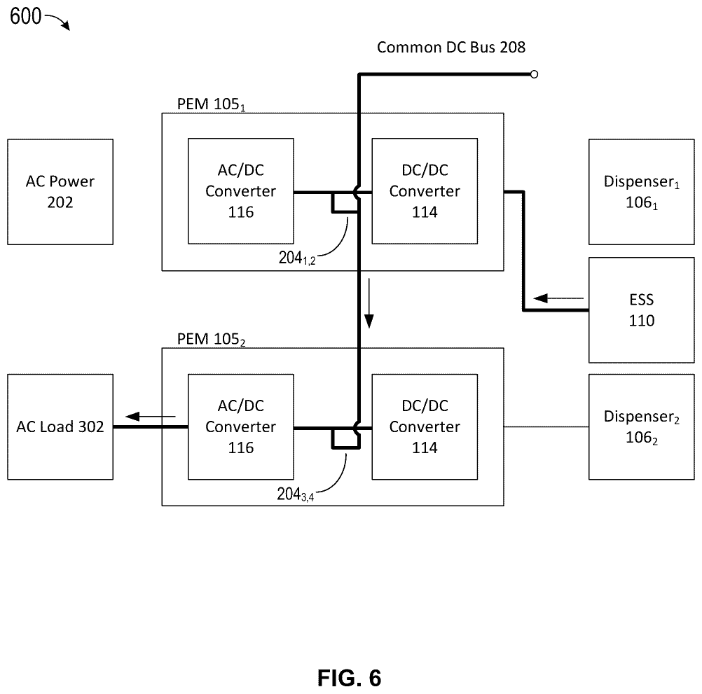

FIG. 6 is an illustrative depiction of power flows during a fourth mode of operation 600 of the power electronics equipment, in accordance with some embodiments of the present disclosure. In some embodiments, the fourth mode of operation corresponds to receiving stored power from one or more ESS 110 and providing the stored power to one or more AC load 302, as shown. As shown by the arrows and the bolded lines of FIG. 6, power flows from ESS 110, respectively through PEMs 105₁ and 105₂, and to AC load 302. During the fourth mode of operation 600, switches 204_{1,2} and 204_{3,4} may be closed such that power may flow through common DC bus 208. This power flow couples PEM 105₁ (and DC/DC converter 114 therein) to PEM 105₂ (and DC/DC converter 114 therein) such that the former PEM receives stored power from ESS 110 and the latter PEM provides at least a portion of the stored the stored power to one or more AC load 302.

The fourth mode of operation 600 shown in FIG. 6 may correspond to powering one or more AC load 302 (via one or more AC/DC converter 116) using power stored in ESS 110. This mode of operation may be desirable for powering the one or more AC load 302 (e.g., a connected building, a compressor, common electrical appliances, any other suitable equipment, or any combination thereof) when AC power 202 is unavailable (e.g., during a blackout or in an off-grid configuration). When AC power 202 is available, this mode may be desirable to provide more renewable and/or less costly power, to provide support to the electric grid (e.g., to provide demand response, load shedding, peak shaving, frequency regulation, voltage regulation, spinning reserves, operating reserves, any other ancillary services, or any combination thereof), to use on-site energy, or any combination thereof. In some embodiments, AC load 302 may not be present. With or without the presence of AC load 302, in some embodiments, the fourth mode of operation may include providing power to electrical grid 102 through equipment indicated by AC power 202. In some embodiments, common DC bus 208 may not be activated and power may flow directly from ESS 110 through a single PEM (e.g., PEM 105₁) and to an AC load (e.g., AC load 302 or a grid-connected load through AC power 202). In some embodiments, switches 206 may directly connect multiple PEMs 105 to ESS 110 (e.g., to draw greater power from ESS 110 and power greater AC loads).

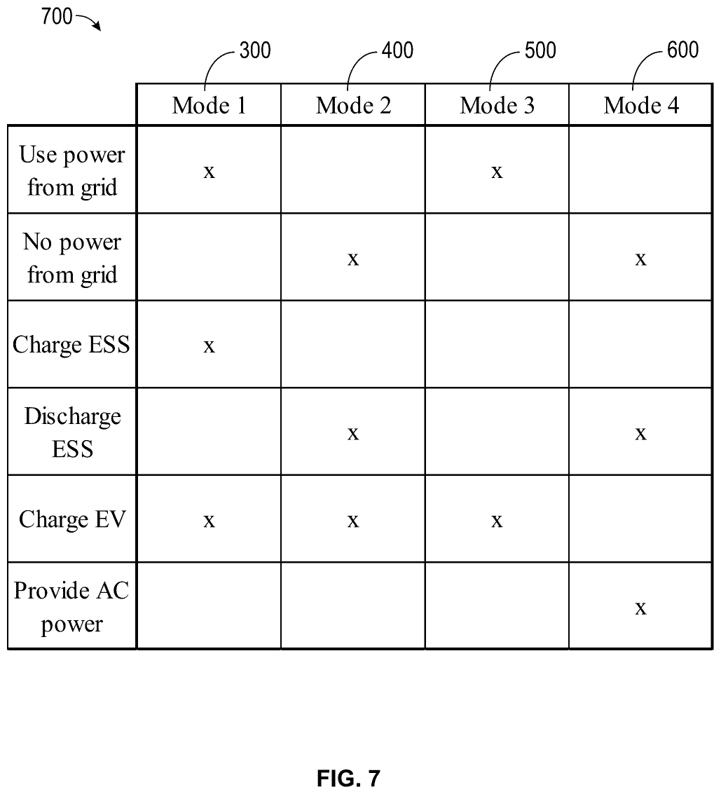

FIG. 7 is an illustrative state diagram 700 describing various modes of operation of the power electronics equipment, in accordance with some embodiments of the present disclosure. In FIG. 7, the left-most column is a non-exhaustive list of conditions relevant to the power electronics equipment, and the top-most row is a list of the operation modes 1, 2, 3, and 4, which may respectively correspond to the respective modes of operation 300, 400, 500, and 600 (e.g., as shown in FIGS. 3-6). The grid of boxes within the first row and first column each correspond to a single condition and a single operation mode, and each such box contains an ‘x’ when the condition in-line with the box may pertain to the mode in-column with the box. For example, situations where the power electronics equipment uses power from the grid may correspond to either of the mode 1 300 (i.e., the first mode) or mode 3 500 (i.e., the third mode). In contrast, situations where the power electronics equipment uses power from a source other than the grid may correspond to either of mode 2 400 (i.e., the second mode) or mode 4 600 (i.e., the fourth mode). In mode 1 300, the ESS may be charged. In mode 2 400 and mode 4 600, the ESS may be discharged (e.g., to provide power to a DC or AC load). In mode 1 300, mode 2 400, and mode 3 500, one or more electric vehicles may be charged. In mode 4 600, AC power may be provided to one or more loads (e.g., to support the grid or to power AC equipment in off-grid configurations and/or during a loss of grid power).

In some embodiments, memory 111 of PEM 105 may store data indicative of at least the conditions and operation modes of state diagram 700. In some embodiments, memory 111 of PEM 105 may store operational instructions corresponding to the conditions and operation modes of state diagram 700. In response to the aforementioned data, the aforementioned instructions, other suitable indications, or any combination thereof, control circuitry 112 of PEM 105 may accordingly operate equipment within or coupled to the PEM, including AC/DC converter 116, DC/DC converter 114, switches 204, and switches 206 to instantiate a given mode of operation. In some embodiments (e.g., any mode of operation where power is shared via the common DC bus 208), control circuitry 112 of a respective PEM 105 that is actively providing or receiving power from the common DC bus 208 may operate one or more power converter of the respective PEM in view of one or more other PEM that is also actively providing or receiving power from the common DC bus 208. For example, consistent with at least mode 2 400 or mode 4 600, control circuitry 112 of a first PEM 105 may operate the DC/DC converter 114 therein to receive power (e.g., from ESS 110) and provide that power to the common DC bus 208; correspondingly, control circuitry 112 of a second PEM 105 may operate the DC/DC converter 114 therein to receive power from the common DC bus 208 and provide that power to a load (e.g., dispenser 106 or AC load 302 via an AC/DC converter 116).

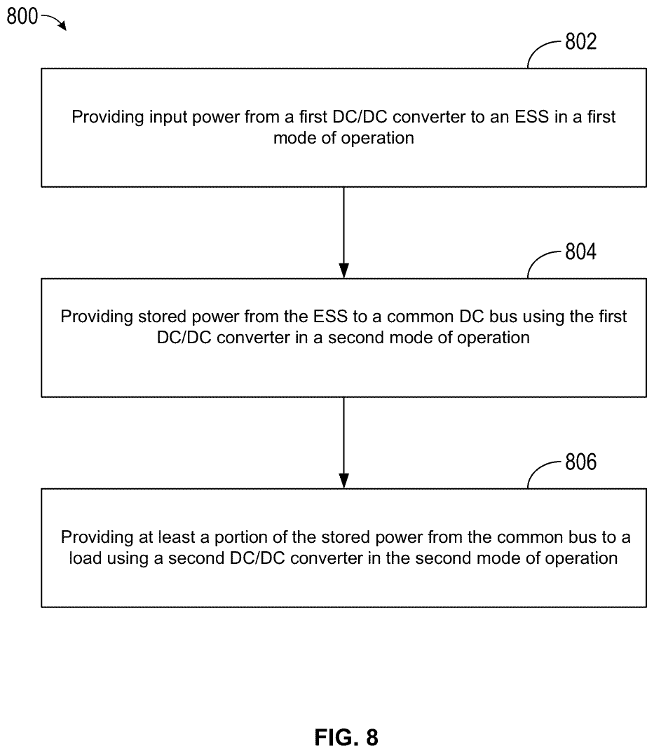

FIG. 8 is an illustrative flowchart of a method 800 for providing power to a load and/or an energy storage system, in accordance with some embodiments of the disclosure. At 802, input power is provided from a first DC/DC converter (e.g., the DC/DC converter 114 of a first PEM 105) to an ESS (e.g., ESS 110) in a first mode of operation (e.g., mode 300). At 804, stored power from the ESS (e.g., ESS 110) is provided to a common DC bus (e.g., common DC bus 208) using the first DC/DC converter in a second mode of operation (e.g., mode 400). At 806, at least a portion of the stored power is provided from the common bus to a load (e.g., dispenser 106) using a second DC/DC converter (e.g., the DC/DC converter 114 of a second PEM 105) in the second mode of operation. In some embodiments, the method also includes providing at least a portion of the stored power from the common bus to a load (e.g., AC load 302) using an AC/DC converter (e.g., the AC/DC converter 116 of a second PEM 105).

The processes discussed above are intended to be illustrative and not limiting. One skilled in the art would appreciate that the steps of the processes discussed herein may be omitted, modified, combined and/or rearranged, and any additional steps may be performed without departing from the scope of the invention.

The foregoing is merely illustrative of the principles of this disclosure, and various modifications may be made by those skilled in the art without departing from the scope of this disclosure. The above-described embodiments are presented for purposes of illustration and not of limitation. The present disclosure also can take many forms other than those explicitly described herein. Accordingly, it is emphasized that this disclosure is not limited to the explicitly disclosed methods, systems, and apparatuses, but is intended to include variations thereto and modifications thereof, which are within the spirit of the following claims.

What is claimed is:

1. A system comprising:
a first direct current to direct current (DC/DC) converter configured to:
provide DC input power to an energy storage system (ESS) in a first mode of operation; and
receive stored power from the ESS and provide the stored power to a common DC bus in a second mode of operation; and
a second DC/DC converter configured to receive at least a portion of the stored power from the common DC bus and provide it to a load in the second mode of operation.

2. The system of claim 1, wherein each of the first DC/DC converter and the second DC/DC converter is electrically isolated and configurable to provide bidirectional power flow and wherein the second DC/DC converter is further configured to provide input power to the ESS in the first mode of operation.

3. The system of claim 1, further comprising at least one alternating current to direct current (AC/DC) converter configured to provide the DC input power to the common DC bus in the first mode of operation.

4. The system of claim 1, wherein the first DC/DC converter is further configured to provide input power to a load in a third mode of operation.

5. The system of claim 1, wherein the first DC/DC converter is configured to receive a portion of the stored power from the ESS and provide it to the common DC bus for grid forming or grid support in a fourth mode of operation.

6. The system of claim 5, further comprising at least one AC/DC converter configured to receive the portion of the stored power from the common DC bus and provide it for the grid forming or grid support in the fourth mode of operation.

7. The system of claim 5, wherein the second DC/DC converter is inactive in the fourth mode of operation.

8. The system of claim 1, further comprising:
a plurality of DC/DC converters including the first DC/DC converter and the second DC/DC converter; and
a switching matrix configured to connect or disconnect an input of each of the plurality of DC/DC converters to the common DC bus.

9. The system of claim 1, further comprising:
a plurality of DC/DC converters including the first DC/DC converter and the second DC/DC converter; and
a switching matrix configured to connect or disconnect an output of each of the plurality of DC/DC converters to a plurality of loads, wherein:
the plurality of loads comprises the ESS and at least one electric vehicle.

10. The system of claim 1, further comprising:
a first power electronics module (PEM) comprising a first AC/DC converter having an output coupled to an input of the first DC/DC converter; and
a second PEM comprising a second AC/DC converter having an output coupled to the input of the second DC/DC converter.

11. A method comprising:
in a first mode of operation:
providing input power from a first direct current to direct current (DC/DC) converter to an energy storage system (ESS); and
in a second mode of operation:
providing stored power from the ESS to a common DC bus using the first DC/DC converter; and
providing at least a portion of the stored power from the common DC bus to a load using a second DC/DC converter.

12. The method of claim 11, wherein each of the first DC/DC converter and the second DC/DC converter is electrically isolated and configurable to provide bidirectional power flow, the method further comprising, in the first mode of operation, providing input power from the second DC/DC converter to the ESS.

13. The method of claim 11, further comprising, in the first mode of operation, providing the DC input power to the common DC bus using at least one alternating current to direct current (AC/DC) converter.

14. The method of claim 11, further comprising, in a third mode of operation, providing input power to a load using the first DC/DC converter.

15. The method of claim 11, further comprising, in a fourth mode of operation, using the first DC/DC converter to receive a portion of the stored power from the ESS and provide it to the common DC bus for grid forming or grid support.

16. The method of claim 15, further comprising, in the fourth mode of operation, using at least one AC/DC converter to receive the portion of the stored power from the common DC bus and provide it for the grid forming or grid support.

17. The method of claim 15, further comprising, in the fourth mode of operation, inactivating the second DC/DC converter.

18. The method of claim 11, further comprising:
connecting or disconnecting an input of each of a plurality of DC/DC converters to the common DC bus using a switching matrix, wherein the plurality of DC/DC converters includes the first DC/DC converter and the second DC/DC converter.

19. The method of claim 11, further comprising:
connecting or disconnecting an output of each of a plurality of DC/DC converters to a plurality of loads using a switching matrix, wherein the plurality of DC/DC converters includes the first DC/DC converter and the second DC/DC converter and wherein the plurality of loads comprises the ESS and at least one electric vehicle.

20. A system comprising:
a first power electronics module (PEM) comprising a first alternating current to direct current (AC/DC) converter coupled to a first direct current to direct current (DC/DC) converter;
a second PEM comprising a second AC/DC converter coupled to a second DC/DC converter;
a common DC bus selectively connectable to the first PEM between the first AC/DC converter and the first DC/DC converter and to the second PEM between the second AC/DC converter and the second DC/DC converter; and
an energy storage system (ESS), wherein:
in a first mode of operation, the first DC/DC converter is configured to provide DC input power to the ESS; and
in a second mode of operation:
the first DC/DC converter is configured to receive stored power from the ESS and provide the stored power to the common DC bus; and
the second DC/DC converter is configured to receive at least a portion of the stored power from the common DC bus and provide it to an electric vehicle.
